(19) United States
(12) Patent Application Publication
(10) Pub. No.: US 2026/0278604 A1
(43) Pub. Date: Sep. 17, 2026

(54) BLOCKCHAIN-BASED DATA TRANSACTION DEVICE AND METHOD

(71) Applicant: LG ELECTRONICS INC., Seoul (KR)

(72) Inventors: Changsu HA, Seoul (KR); Soochul YANG, Seoul (KR); Sanglee PARK, Seoul (KR)

(73) Assignee: LG ELECTRONICS INC., Seoul (KR)

(21) Appl. No.: 19/221,798

(22) Filed: May 29, 2025

(30) Foreign Application Priority Data
Mar. 11, 2025 (KR) 10-2025-0031574

(51) Int. Cl. G06Q 20/40; G06Q 20/36; G06Q 20/38; H04L 9/32

(52) U.S. Cl. CPC G06Q 20/401; G06Q 20/36; G06Q 20/3829; H04L 9/3213; G06Q 2220/00

(57) ABSTRACT

The present disclosure relates to a data transaction device that allows data collected by a user’s device to be traded via a blockchain network. The device collects raw usage data, generates summary information, selects marketable data based on a purchaser's request, and registers the selected data in a blockchain network. In addition, an access rights is managed by issuing a token related to the registered marketable data, and a transaction cost incurred when registering the data in the blockchain and issuing the token is paid via an embedded wallet.

This application claims the benefit of Korean Patent Application No. 10-2025-0031574 filed on Mar. 11, 2025, which is hereby incorporated by reference as if fully set forth herein.

### BACKGROUND

### FIELD

The present disclosure relates to a device and a method for transacting data, and more particularly, to a device and a method for selecting usage data of a device and selling the selected data on the basis of a blockchain network.

### DISCUSSION OF THE RELATED ART

Device usage data of a user is regarded as an important asset in the modern society and is used in various industrial fields. In particular, in a digital environment, user data is used for various purposes such as advertising, content recommendation, market analysis, and artificial intelligence model learning, and has become a factor to which companies and research institutes assign significant value.

With the recent spread of smart devices, a vast amount of user data is being generated from a TV, a smartphone, an IoT device, and the like. Such data reflect a consumption pattern, a preference, a content usage behavior, and the like of the user, and a more personalized service is able to be provided by analyzing them.

For example, viewing data collected from the TV may be utilized to optimize a content recommendation system or to measure an effect of a specific advertisement.

Data transaction is one of ways to maximize the value of such data, and refers to an intermediary process between a subject (an advertiser, a content provider, a research institute, and the like) that needs the data and a subject (an individual, a company, a device manufacturer, and the like) that owns the data.

In existing data transaction methods, it was common to collect and trade the data via a centralized platform. For example, in an online advertising industry, a specific platform collects the user data and provides the same to the advertiser, and the advertiser executes a customized advertisement based on the same.

However, the existing data transaction methods have a limitation in that the data provider does not receive appropriate compensation or it is difficult to verify data reliability.

Accordingly, there is a growing need for a system for establishing a new data transaction environment in which the data provider may receive the fair compensation and the data purchaser may secure reliable data.

In one example, with advent of a blockchain technology, a possibility that the blockchain technology is used as a method to secure reliability and transparency of the data is increasing. The blockchain is a technology that minimizes a risk of data manipulation by preventing a data change and storing transaction details in a distributed manner. When the blockchain is applied to the data transaction, a safer transaction environment may be established.

Along with this, as a non-flexible token technology develops, a method for giving ownership of digital assets is attracting attention. The token may be used as a means of granting the rights to own and access specific data. Applying the token to the data transaction may safely manage access to the data and create a structure in which the data provider may receive the clear compensation.

### SUMMARY

A purpose of the present disclosure is to provide a data transaction device that enables transaction of user data collected from a smart device.

In addition, a purpose of the present disclosure is to provide a data transaction system that safely manages access rights to marketable data(transaction data) using a token and guarantees reliability of data.

In addition, a purpose of the present disclosure is to provide a data transaction method of paying a blockchain network fee via an embedded wallet and enabling a data provider to smoothly perform a data transaction even when the data provider does not directly have cryptocurrency.

Technical tasks obtainable from the present disclosure are non-limited by the above-mentioned technical tasks. And, other unmentioned technical tasks can be clearly understood from the following description by those having ordinary skill in the technical field to which the present disclosure pertains.

Additional advantages, objects, and features of the disclosure will be set forth in the disclosure herein as well as the accompanying drawings. Such aspects may also be appreciated by those skilled in the art based on the disclosure herein.

The present disclosure provides a device for collecting usage data of each user and trading the usage data using a blockchain network including a data manager that collects raw usage data(usage source data) of the device and selects marketable data from the raw usage data, a blockchain registrator that registers the marketable data in the blockchain network, and a server that provides a service for trading the usage data and a communicator that is in communication with the blockchain network.

The data manager may generate summary information regarding the raw usage data, and select the marketable data based on a purchase request for the summary information.

The device may further include an embedded wallet with cryptocurrency, and the blockchain registrator may pay a first transaction cost incurred in the registration using a balance held by the embedded wallet.

The embedded wallet may receive the first transaction cost from a purchaser of the marketable data.

The device may further include a token issuer that issues a token related to the registered marketable data, and the token may include an access key for checking the registered marketable data.

The token issuer may pay a second transaction cost incurred in the process of issuing the token using a balance held by an embedded wallet.

The device may further include a display that displays a screen thereon, and the display may include a web page outputter that outputs a web page for trading the usage data, and a button display that displays a button for selling the usage data on the web page when a sales agreement is input from each user.

The display may further include a linkage display that displays linkage information for linking a digital wallet of each user with the data manager on the web page.

The display may further include a request display that displays a purchase request generated by at least one seller on the web page.

The device may further include a sensor that senses a number of users.

Further, as another embodiment of the present disclosure, proposed is a method for transacting data including collecting raw usage data of a device used by a user, selecting marketable data from the raw usage data, registering the marketable data in a blockchain network, issuing a token related to the registered marketable data, and trading the token.

The selecting of the marketable data may include generating summary information regarding the raw usage data, receiving a purchase request for the summary information, and selecting the marketable data from the raw usage data based on the purchase request.

A first transaction cost incurred in the registering of the marketable data in the blockchain network may be paid using a balance held by an embedded wallet included in the device, and a second transaction cost incurred in the issuing of the token may be paid using a balance held by the embedded wallet included in the device.

The embedded wallet may receive the first transaction cost or the second transaction cost from a purchaser of the marketable data.

The token may include an access key for checking the registered marketable data.

Further, as a still another embodiment of the present disclosure, proposed is a data transaction system including a device that generates summary information of usage data of a user, selects marketable data required by a purchaser from the usage data, registers the marketable data in a blockchain network, and issues a token regarding the registered marketable data, a terminal of the user that executes a digital wallet linked with the device, and a server that receives the summary information of the usage data from the device, provides the received summary information to a purchaser terminal, and receives a request for provision of the marketable data based on the summary information from the purchaser terminal, wherein the server provides a reward for the token to the digital wallet of the user when the token is sold.

According to the embodiment of the present disclosure, by allowing the user data collected from the smart device to be traded via the blockchain network, the reliability of the data may be ensured.

In addition, by managing the data access rights using the token, the data provider may more safely trade the data, and the purchaser may secure the unmanipulated data.

In addition, by automatically paying the blockchain network fee via the embedded wallet, the data transaction may be smoothly performed even when the user does not directly buy or hold the cryptocurrency.

Additional scope of applicability of the present disclosure will become apparent from the detailed description below.

However, since various changes and modifications within the idea and scope of the present disclosure may be clearly understood by those skilled in the art, the detailed descriptions, and specific embodiments such as preferred embodiments of the present disclosure should be understood as being set forth only by way of example.

### BRIEF DESCRIPTION OF THE DRAWINGS

FIG. 1 is a diagram for illustrating a data transaction system according to an embodiment of the present disclosure.

FIG. 2 is a flowchart of a data transaction method according to an embodiment of the present disclosure.

FIG. 3 is a diagram illustrating some steps of FIG. 2.

FIG. 4 is a block diagram of a data transaction device according to an embodiment of the present disclosure.

FIG. 5 is an example of a display according to an embodiment of the present disclosure.

FIG. 6 is an example of a linkage display according to an embodiment of the present disclosure.

FIG. 7 is another example of a display according to an embodiment of the present disclosure.

FIG. 8 illustrates an example of a display of a purchaser terminal.

### DESCRIPTION OF SPECIFIC EMBODIMENTS

Description will now be given in detail according to exemplary embodiments disclosed herein, with reference to the accompanying drawings. The same or equivalent components may be provided with the same reference numbers, and description thereof will not be repeated. As used herein, the suffixes “module" and “part" are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical idea disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with" another element, the element can be directly connected with the other element or intervening elements may also be present. In contrast, it will be understood that when an element is referred to as being “directly connected with" another element, there are no intervening elements present.

A singular representation may include a plural representation unless it represents a different meaning from the context.

The terms such as “include" or “have" used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

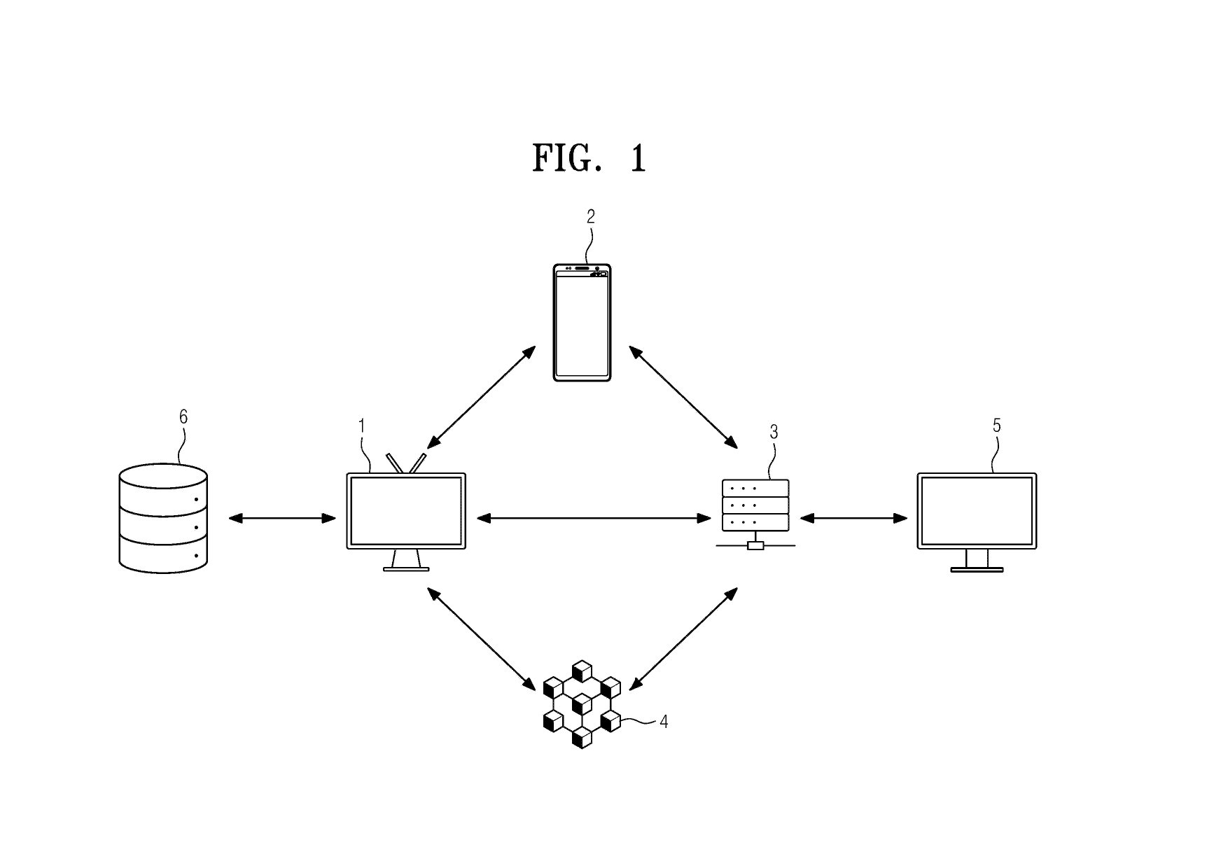

FIG. 1 is a diagram for illustrating a data transaction system according to an embodiment of the present disclosure. The present system may include a series of processes of generating summary information of usage data of a user, selecting marketable data required by a purchaser from among the usage data, registering the marketable data in a blockchain network, and then issuing a token related to the registered marketable data.

A data transaction system 1 of the present disclosure, as a system built to collect device the usage data of the user and to trade the data using a blockchain network, may include a device 1, a user terminal 2, a server 3, a blockchain network 4, a purchaser terminal 5, or a data storage 6 as main elements constituting the system.

The data transaction system 1 may include all of the components shown in FIG. 1, may include only some of the components, or may further include components other than the components shown in FIG. 1.

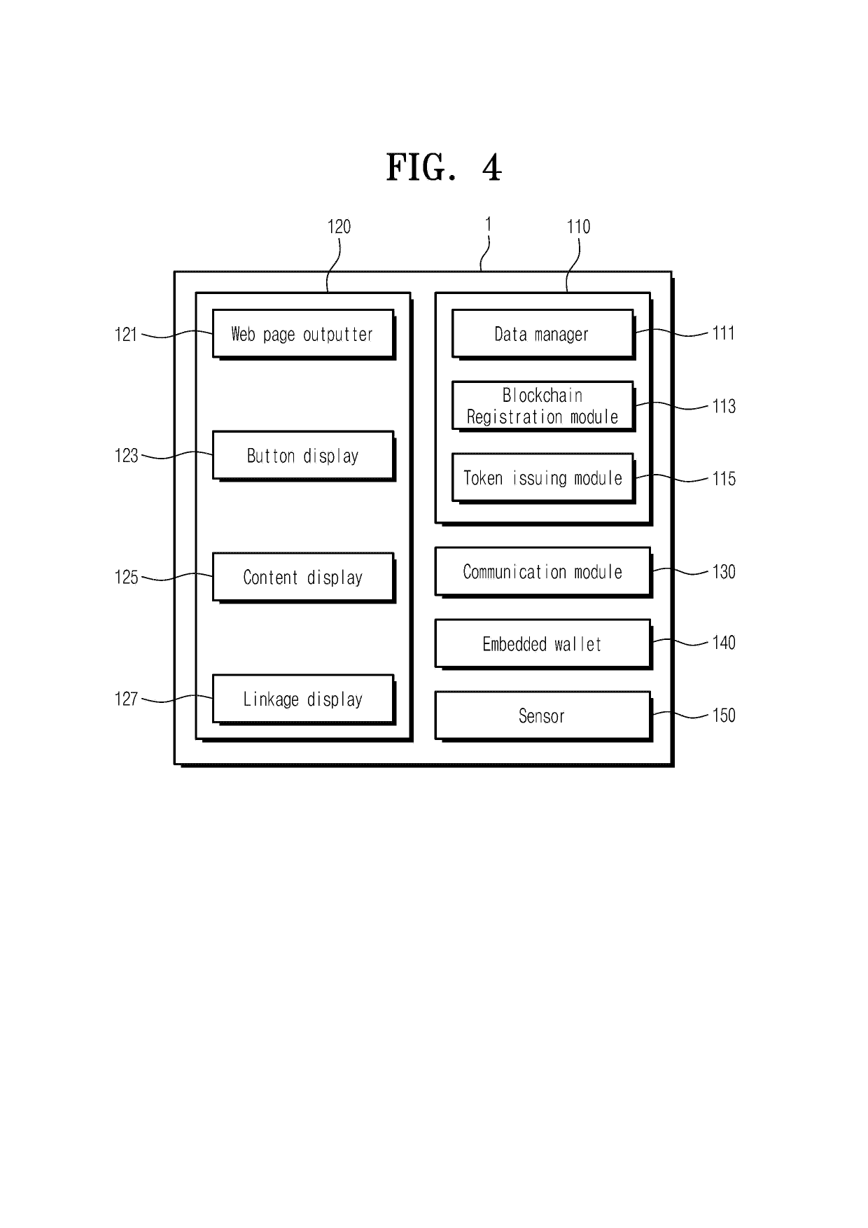

The device 1 may perform a function of collecting raw usage data of the user, generating the summary information, selecting the marketable data, and registering the selected data in the blockchain network 4. In this regard, the device 1 may be a home appliance used by the user, and may include, for example, a television, an air conditioner, a washing machine, a refrigerator, a cleaner, a toaster, or the like. In addition, the device 1 may include an embedded wallet 140, and may serve to pay a transaction cost incurred during the blockchain registration and the token issue. The device will be described in detail with reference to FIG. 4.

The user terminal 2 is a device capable of executing a user's digital wallet. The user may consent sales of the marketable data or check compensation via the terminal 2.

The server 3 may serve to provide a data transaction service, and may perform a function of communicating with the device 1 and the user terminal 2 to process a data transaction request, receiving a purchase request from the purchaser terminal 5, and registering the marketable data in the blockchain network 4.

In addition, the server 3 may provide the summary information received from the device 1 to the purchaser terminal 5, and support a purchaser to proceed with the transaction based on the selected marketable data.

In addition, when the token is sold, the server 3 may provide a reward to the user terminal 2 that executes the user's digital wallet. Accordingly, the data provider may receive direct economic compensation via the data transaction, and the data purchaser may safely utilize the marketable data in the blockchain network.

The blockchain network 4 serves to ensure integrity of the marketable data and to issue the token and record the transaction details. The server 3 and the device 1 may communicate with the blockchain network 4, generate an NFT or other token, and manage access rights to the marketable data.

The purchaser terminal 5, as a terminal used by a subject who wants to purchase the data, may receive the summary information of the device 1 via the server 3, transmit the purchase request, obtain the token issued via the blockchain network, and access the marketable data.

When the purchaser completes the data purchase, the corresponding transaction may be recorded via the blockchain network, and after the transaction is completed, the server 3 may provide the reward to the user terminal 2 that executes the user's digital wallet. This allows the data provider to receive the direct economic reward via the transactions, and allows the data purchaser to safely utilize the data in the blockchain-based reliable transaction environment.

The data storage 6 is a distributed storage that stores the data in the data transaction system of the present disclosure. In the present disclosure, instead of directly storing the marketable data in the blockchain network 4, a method for storing the marketable data in the distributed storage 6, generating an access link of the corresponding data, and then issuing the NFT based on the link and registering the NFT in the blockchain network 4 may be adopted.

The data storage 6 may utilize a distributed file storage system, and typically, a decentralized storage such as an interplanetary file system (IPFS) may be applied.

Unlike an existing method of storing the data in a central server, the distributed storage may have a structure of storing the data in a manner of being distributed to several nodes in the network, and accordingly, the integrity and security of the data may be improved.

In the present system, the marketable data may first be uploaded to the data storage 6, and the uploaded data may be managed in a unique content addressable storage (CAS) manner.

That is, because the data storage 6 has the same hash value as long as the data is not changed, manipulation of the data may be impossible and the integrity may be guaranteed.

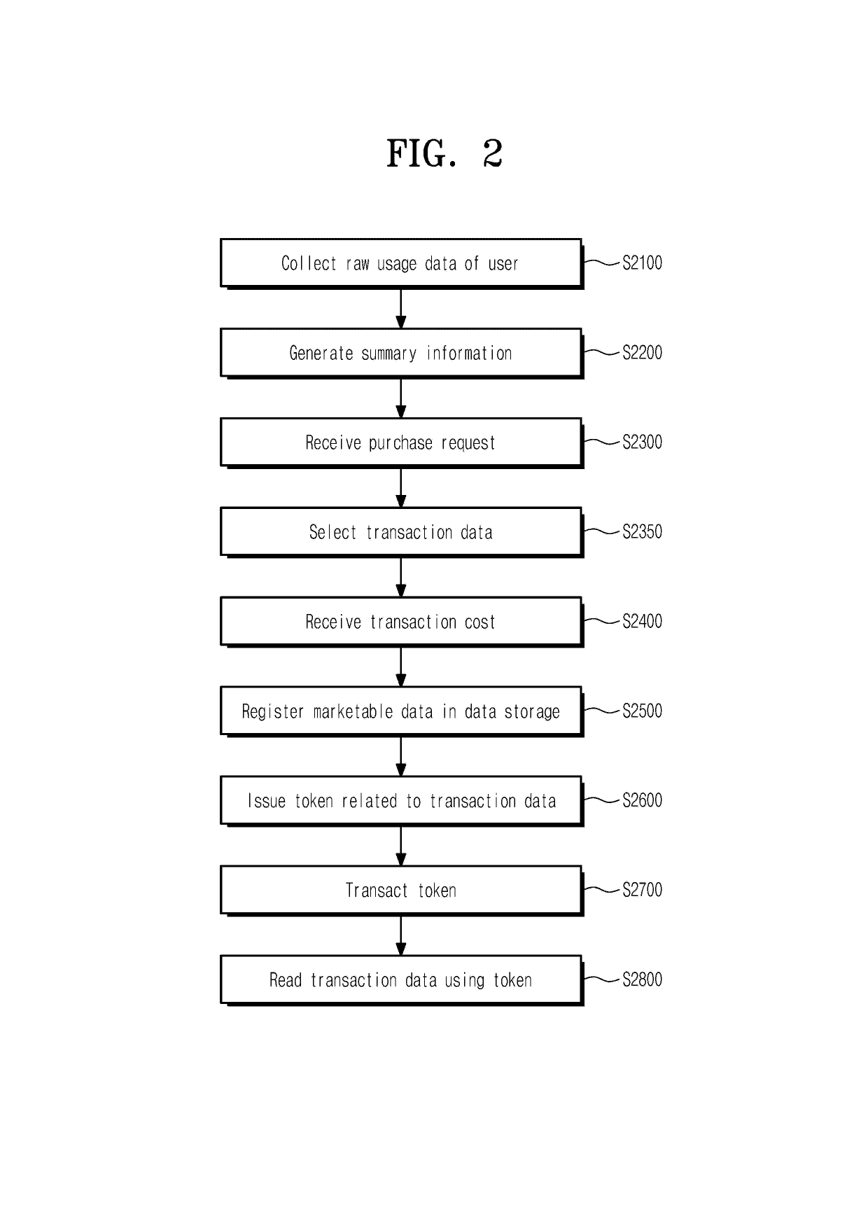

FIG. 2 is a flowchart of a data transaction method according to an embodiment of the present disclosure.

The present method includes a series of processes of collecting the source data generated by the user's device, registering the marketable data using the blockchain network, and then managing the access rights to the corresponding data with the token to perform the transaction.

First, the user's device 1 collects the raw usage data (S2100).

As described above, the device according to an embodiment of the present disclosure may be the home appliance used by the user. For example, the television, the air conditioner, the washing machine, the cleaner, the refrigerator, and the like may be included.

Such source data may mean all usage records generated in the user’s device. For example, various types of data may be included without being limited to a viewing record, a viewing time, a type of content, information on an advertisement watched, OTT usage information, application usage data of the TV, a main use mode and a use time zone of the air conditioner, a main use mode, a use frequency, a use time or number of the washing machine, a door opening number, a use time, and a use mode of the refrigerator, and the like.

The device 1 may include a data manager 11, and may collect, internally store, and manage the raw usage data using the data manager 11.

Next, the data manager 11 of the device 1 analyzes the raw usage data and generate the summary information (S2200). The summary information may not directly include the source data, but may include summarized information such as a type, a collection period, and a size of the data such that the purchaser may evaluate the data in advance. The generated summary information may be transmitted to the server that provides the data transaction service.

Thereafter, the server 3 may provide the corresponding information to the purchaser terminal 5 based on the summary information received from the user’s device 1. After reviewing the summary information provided via the purchaser terminal 5, the purchaser may determine whether to purchase specific data in consideration of desired data type, period, condition, and the like.

In addition, the purchaser may perform an additional data detail request via the server 3 in addition to the summary information, and accordingly, the server 3 may transmit the additional request to the user’s device 1.

As such, the server may receive the purchase request for the specific data from the purchaser terminal 5 (S2300).

That is, the server may collect the summary information of the device and identify a collected data status, receive the purchase request, and match the information that may be provided by the user with the information desired by the purchaser.

For example, the purchaser may determine a target product type for which data is to be collected, may determine a desired information type among data stored with respect to the target product, and may set a desired period and a desired number. When the data purchaser generates the data purchase request as such, the corresponding collection conditions may become the purchase request and may be transmitted to the device 1, and may be displayed on a request display 129.

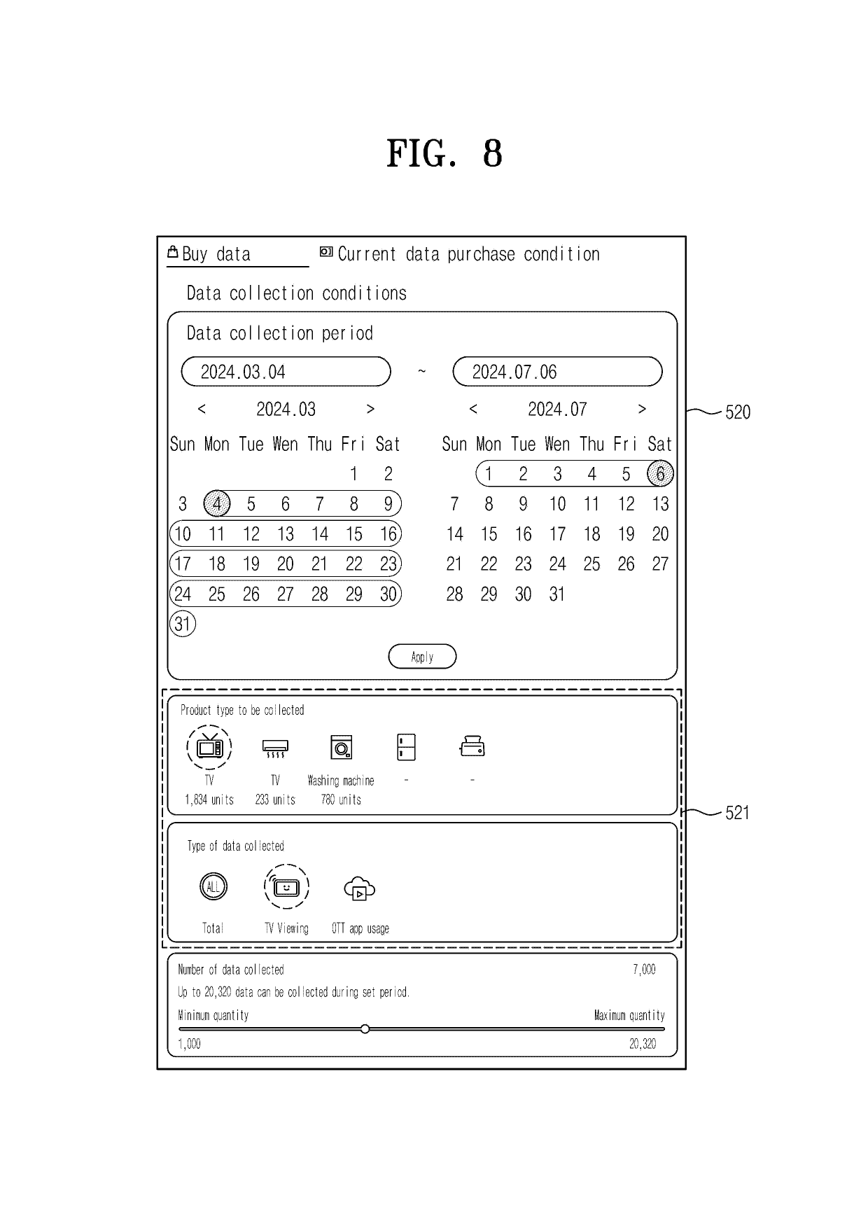

FIG. 8 illustrates an example of a display 520 of the purchaser terminal 5. Referring to FIG. 8 together, the display 520 may include a data request generator 521. The data request generator may display selectable data types, and the purchaser may select the desired data type from among the possible options.

For example, the purchaser may select the collection target product type from among the displayed items. In this regard, the product is sufficient as long as it may provide the usage data, and the type thereof is not limited. For example, the purchaser may generate a request to purchase TV data or usage data of the washing machine.

Alternatively, the purchaser may select a type of data to be collected. The type of data to be collected may be different depending on the collection target product type. For example, when the TV usage data is selected, the viewing data, app usage data, and the like may be selected.

Next, the data manager of the device may select the marketable data from the raw usage data based on the received purchase request (S2350). In this regard, the marketable data may include only data corresponding to the purchase request of the purchaser among the raw usage data.

With such a method, the method according to an embodiment of the present disclosure may not indiscriminately register all of the raw usage data in the blockchain network, but select and register only the data whose actual purchase demand has been identified.

In addition, a gas fee incurred in the process of registering the data in the blockchain network is minimized, thereby reducing storage space and operation costs.

Next, when the purchase request is approved, the server 3 may perform a procedure of receiving a transaction cost for registering the corresponding marketable data in the blockchain network 4 (S2400).

The purchaser may directly pay the transaction cost, but an embedded wallet 30 included in the device 1 may manage a first transaction cost incurred in the process of registering the marketable data in the blockchain.

In this process, the embedded wallet 30 may receive the corresponding transaction cost from the purchaser. That is, when receiving the purchase request of the purchaser, the server may make a request for the necessary gas fee (the transaction cost) to the purchaser. When the purchaser pays the gas fee required for the purchase request, the server may transmit the paid fee to the embedded wallet included in the device.

With such a method, in the data transaction method according to an embodiment of the present disclosure, a procedure in which the user directly secures a gas fee for data sales may be omitted. In general, to perform such a transaction process, the user (a seller) had to directly sign up for a membership of an exchange and purchase a coin used as the gas fee to bear the transaction cost, but the present disclosure allows such a process to be omitted, thereby improving accessibility of the data transaction and reducing a burden on the user.

Next, when the transaction cost is normally received, a blockchain registrator 13 of the device 1 may register the selected marketable data in the distributed data storage (e.g., the IPFS or the blockchain).

Because the device directly registers the marketable data, modification and forgery are impossible, and data transparency is able to be guaranteed. Accordingly, the purchaser may trust the marketable data.

In this regard, the registered marketable data is limited to data previously approved by the user, and because the registered data is stored in the distributed storage based on a hash, modulation is impossible.

For example, the link hash value may be changed when the data is manipulated, and the data access rights may be managed based on a Web3 sales record when the data is sold.

In a next step, a token issuer 15 of the device 1 generates a token that grants the access rights to the registered marketable data (S2600). This token may be issued in a form of a blockchain-based asset such as the NFT, and may include an access key for identifying the registered marketable data.

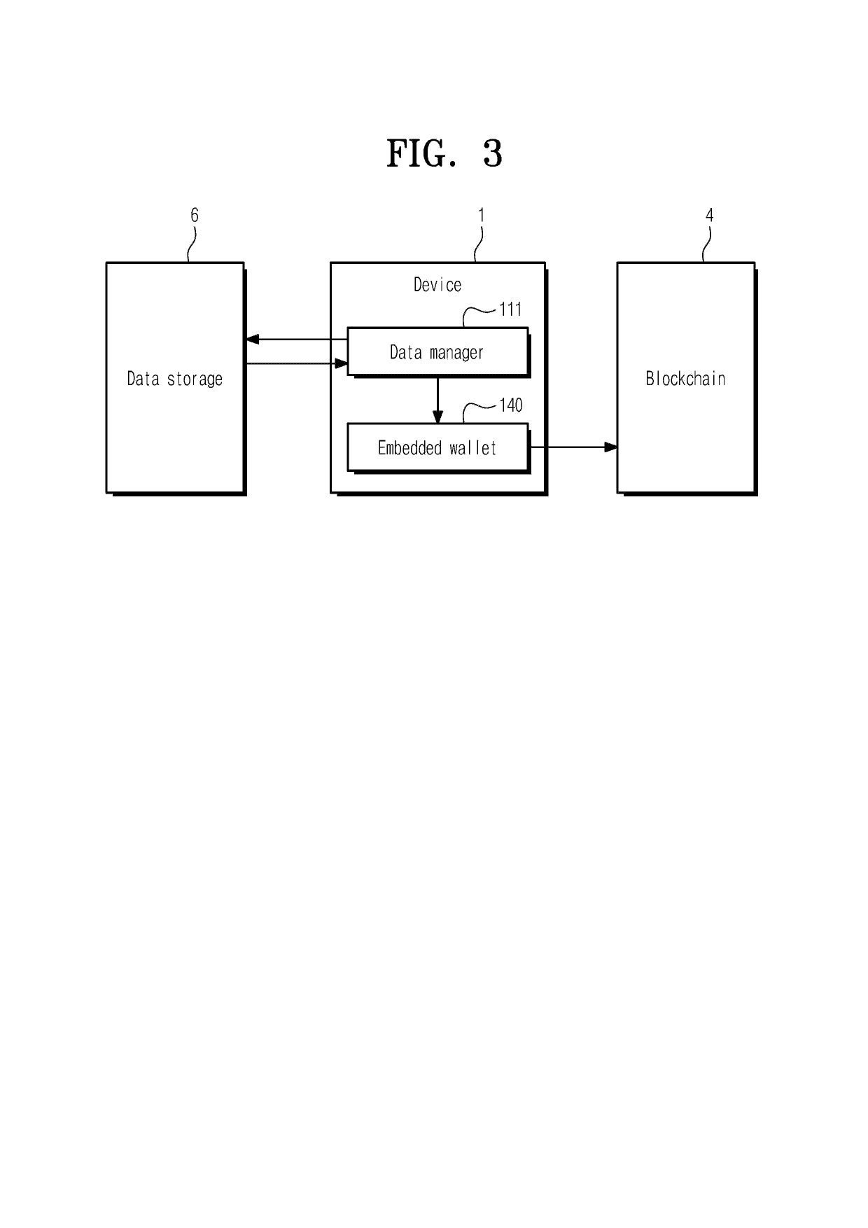

More specifically, when the data manager uploads the marketable data on the data storage (e.g., the IPFS or the blockchain), a data link including an address of the marketable data on the data storage may be returned. This will be described in detail with reference to FIG. 3.

Then, the token issuer included in the device may issue the returned data link as the NFT on the blockchain network 4. Because the device itself has the embedded wallet, the NFT may be registered by the embedded wallet of the device.

The issued NFT may include the access key, and the purchaser who has purchased this NFT may access and read the marketable data using the NFT.

The NFT may include not only the access key but also a data reading period or the like. In this case, the access to the marketable data may not be available except for the data reading period. Further, because the NFT is a non-fungible token, when this NFT is resold to another purchaser, the previous purchaser will no longer have the access to the data.

The NFT may be registered in the blockchain network by the embedded wallet of the device. In this regard, the blockchain network where the NFT is registered may be, when the distributed data storage in which the marketable data is registered is a blockchain network, may be the same network as or may be a different network from the blockchain network.

In one example, also in the process of issuing the NFT, a blockchain transaction cost may be incurred, and this cost may be paid using a balance held by the embedded wallet 30.

Thereafter, the server 3 may support the transaction of the corresponding token (NFT) with the purchaser terminal 5 (S2700), and the purchaser may read the marketable data registered in the blockchain network 4 by securing the token (NFT) (S2800).

In this regard, the purchaser may pay the cost to the server to purchase the NFT, or may pay the cost to the user based on a smart contract. The case of paying the cost to the server will be described in more detail. When the purchaser pays the cost to the server, the server may provide the reward to a user's mobile wallet, the NFT may be owned by the purchaser, and the marketable data accessible using the access key may be transmitted to the purchaser for reading. Alternatively, the user's mobile wallet may be linked with the device to receive the reward via the device.

As shown in FIG. 2, the data transaction method of the present disclosure uses the blockchain network such that the data generated by the user is transacted in a reliable manner, and uses the NFT or other blockchain-based tokens to safely manage the data access rights.

In addition, to reduce the user's direct blockchain transaction performance burden, the embedded wallet 30 may be used to automatically pay the transaction cost. This method may provide the environment in which the data provider may receive the appropriate compensation while ensuring the data integrity.

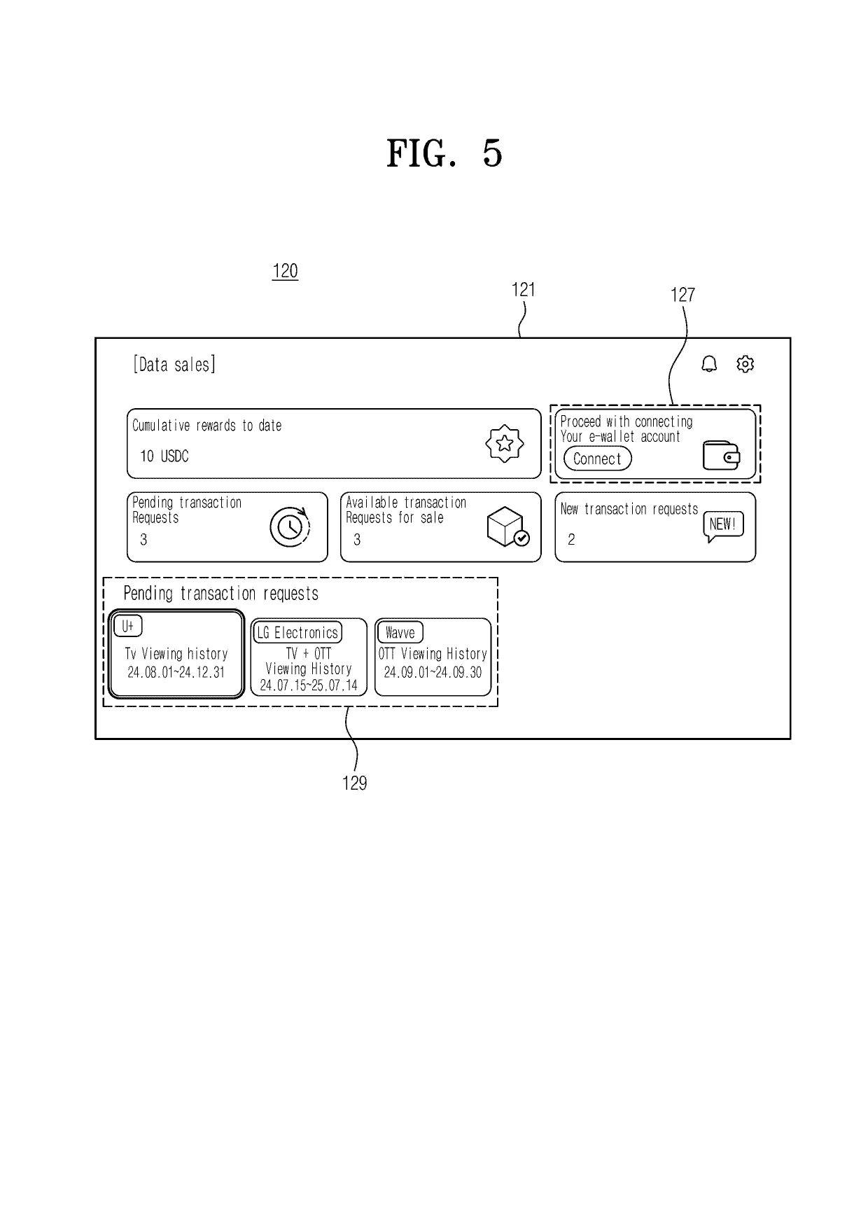

FIG. 3 is a diagram illustrating operation S2500 in FIG. 2. The device according to an embodiment of the present disclosure may include the data manager 111 and the embedded wallet 140. A detailed description thereof will be made later in FIG. 5.

The data manager 111 may collect the raw usage data collected by the device 1. Among them, the marketable data may be selected and registered in the data storage 6 (S2500). The data storage may be the distributed data storage as described above.

Because it may be inefficient to register all of the marketable data in the blockchain, the marketable data may be accessed in a method of registering the marketable data in a separate data storage and registering only a link connected to a location of the data storage in which the marketable data is registered in the blockchain.

When the marketable data is registered in the data storage 6, the data storage 6 may return the link to the location where the marketable data is stored to the device 1. The data manager 111 may receive the returned link and transmit the same to the embedded wallet 140 embedded in the device.

The embedded wallet 140 may be an electronic wallet having a device-specific blockchain account, and the blockchain may be accessed by the device itself.

The embedded wallet may receive the link and receive an NFT generation request. The embedded wallet 140 may generate NFT and register the NFT on the blockchain network 4, and in this case, the NFT may be generated including information on the link.

Accordingly, when the purchaser purchases the corresponding NFT, the access key for the link may be included in the NFT, and the stored marketable data may be read by accessing the link using the access key.

Hereinafter, a data transaction device according to an embodiment of the present disclosure will be described with reference to FIGS. 4 to 7. FIG. 4 is a block diagram of a data transaction device according to an embodiment of the present disclosure.

The data transaction device 1 is a device built to collect the usage data of the user and register the same in the blockchain network to be transacted. The present device may include the data manager 111, a blockchain registrator 113, the token issuer 115, a communicator 130, the embedded wallet 140, a sensor 150, and a display 120.

The data manager 111 may serve to collect the raw usage data of the user, generate the summary information, and select the marketable data.

The raw usage data may include the viewing record, the OTT usage history, the application usage data, and the like generated by the user’s device, and the device may internally store and manage the same. The raw usage data may include device identification information, viewing session information, content information, advertisement watching information, and the like.

Device identification and state information may be included in the raw usage data. For example, information such as a TV ID, which is a unique identifier of the TV, a data collection time point indicating a time point at which data is collected, a state of the TV indicating a power state or an operation mode of the TV, and the like may be included.

Further, the viewing session information may be stored. This, as information on a specific session in which the user has watched the TV, may include data such as viewing session identification information, a start time of the viewing session, an end time of the viewing session, and the like.

The watched content information may also be included in the raw usage data. Information such as the viewed content information indicating information of a program viewed by the user, a content type indicating a type of content, a unique identifier of a channel that is an identifier of a specific channel, a channel name indicating a name of the channel, a unique identifier of a program that uniquely identifies the program, a content title indicating a title of the program, a content genre to which the program belongs, a content viewing start time indicating a time when the user starts viewing the specific content, and a content viewing end time indicating a time when the content viewing is ended may be included.

In addition, the raw usage data may include viewer number information. The number of viewers may indicate the number of actual users who watched the TV, and more accurate viewer information may be recorded using an mmWave sensor.

The advertisement watching information may also be stored. Watched advertisement information including information on an advertisement watched by the user, a unique identifier of the advertisement that is a unique identifier of the advertisement, an advertisement title indicating a title of the advertisement, an advertisement watching start time indicating a time when the user starts to watch the advertisement, an advertisement watching end time indicating a time when the advertisement watching is ended, whether the advertisement has been skipped indicating whether the user has skipped the advertisement, the number of viewers who watched the advertisement, and the like.

As described above, the raw usage data includes data for comprehensively analyzing a TV usage pattern and a content consumption behavior of the user, and such data is used to select the marketable data in the data transaction system and register the selected data in the blockchain network.

The summary information does not directly include the source data, but includes information such as the size, the type, and the collection period of the data so that the purchaser is able to evaluate the data in advance. Thereafter, when the purchaser requests the purchase of the specific data based on the summary information, the data manager 111 may select the corresponding marketable data and prepare for the blockchain registration thereof.

The blockchain registrator 113 may serve to register the marketable data in the blockchain network. When the data is registered in the blockchain network, the data may be recorded in the unchangeable form, and the integrity of the data may be guaranteed.

In addition, to pay the transaction cost incurred in the blockchain registration process, the present device may include the embedded wallet 140, and may automatically process the blockchain registration cost via the corresponding wallet. The transaction cost may be provided directly from the purchaser, or the embedded wallet may receive the corresponding cost from the purchaser and perform the blockchain registration.

The token issuer 115 may serve to manage the access rights to the marketable data registered in the blockchain network. The NFT or other blockchain-based tokens may be generated based on the marketable data, and the corresponding token may include the access key for identifying the data access rights. Also in the process of issuing the token, the blockchain transaction cost is incurred, which may be paid using the balance held by the embedded wallet.

The communicator 130 may serve to transmit and receive the data between the device and the server, the blockchain network, the user terminal, and the purchaser terminal. The summary information may be transmitted, the purchase request may be received, and blockchain registration and token issuance information may be shared via communication with the server. In addition, the digital wallet of the user may be linked via communication with the user terminal, and the marketable data may be provided and the NFT or token transaction may be mediated via communication with the purchaser terminal.

The embedded wallet 140 may serve to hold cryptocurrency for paying the blockchain transaction cost. As the device 1 directly owns the wallet, the transaction may be performed with the account of the device. In addition, the transaction costs incurred in the processes of registering the blockchain and issuing the token may be automatically processed, and the transaction may be smoothly performed by receiving the corresponding costs from the purchaser.

The sensor 150 included in the data transaction device 1 may be mounted to more accurately collect the device usage data of the user. In the present embodiment, the mmWave sensor may be included, and this sensor may be embedded in the home appliance such as the TV to measure the actual number of users, and enable more reliable data generation based on the measurement.

The sensor 150 may perform a function of measuring the number of users using the device. For example, the mmWave sensor embedded in the TV may sense presence or absence of an actual user using a specific device in an indoor environment and the number of viewers, and may provide more reliable user behavior data in association with data such as channel viewing information, an OTT app usage time, or the like.

Using this sensor, unlike an existing simple viewing data collection method, whether an actual person is using the device may be determined. For example, even when the TV is turned on, whether the user is actually watching the TV may be identified, and accordingly, accuracy and meaning of the data may be enhanced.

In addition, the sensor 150 may operate in a manner capable of sensing the number of people while protecting privacy of the user. Compared to a general camera-based people number measurement method, the mmWave sensor may identify the number of people in real time based on non-identification information, which is more safe in terms of the user privacy protection.

The data transaction device of the present disclosure may transmit the data collected using the sensor 150 to the data manager 111, and then may provide the reliable user data in the processes of generating the summary information, selecting the marketable data, and registering the selected data in the blockchain network.

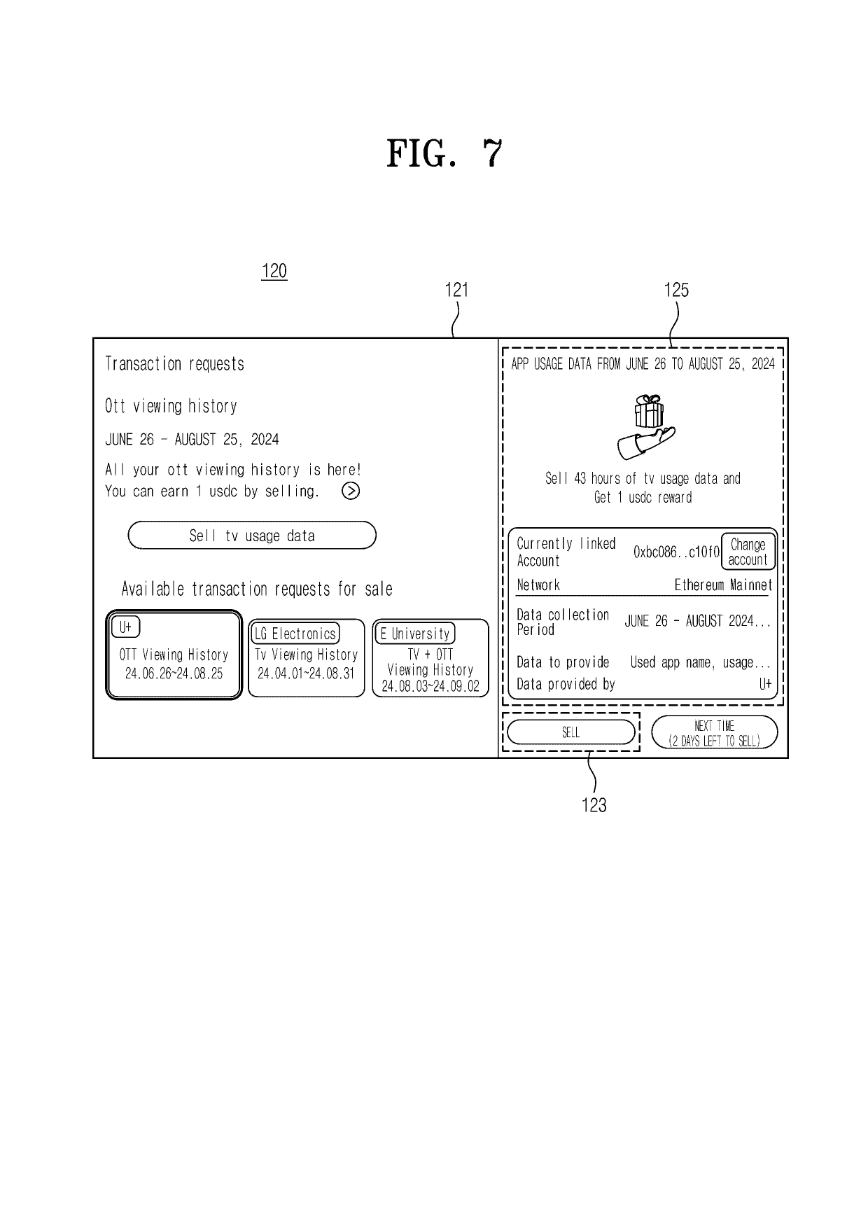

The display 120 may serve to visually provide data transaction related information to the user. A web page outputter 121 may output a web page related to the transaction of the usage data, and a button display 123 may display a sales button such that the user is able to sell the data. A linkage display 127 may display information to link the user's digital wallet with the data manager, and a request display 129 may display the purchase request generated by the purchaser to the user. Hereinafter, the display will be described in detail with reference to FIGS. 5 and 7.

FIGS. 5 and 7 are examples of a display according to an embodiment of the present disclosure.

The data transaction device of the present disclosure may include the display 120, and the display 120 may visually provide the data transaction related information to the user. As illustrated in FIG. 5, the display 120 may include the web page outputter 121, and the user may use the data transaction service via a web page.

The web page outputter 121 may include the linkage display 127 that enables linkage of the user's digital wallet with the data manager, and may allow the user to connect the digital wallet to the data manager and perform the data transactions.

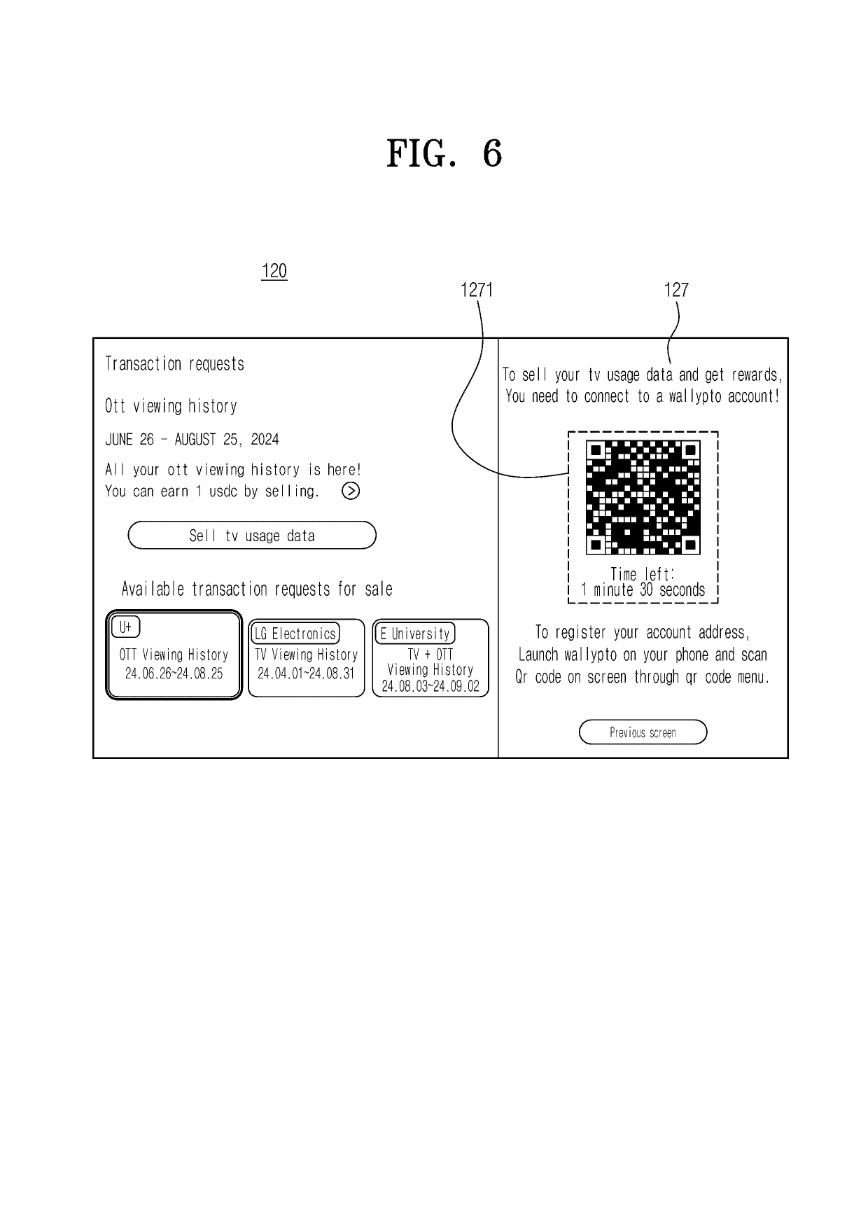

Referring to FIG. 6 together, the linkage display 127 may visually provide information for linking the user's digital wallet with the data transaction device, and may display linkage information using a QR code 1271 therefor. The QR code may support the user to easily perform the linking process without a separate manual input, and may allow a digital wallet application to be automatically executed or linkage with the specific blockchain network to be achieved when the user scans the QR code using a terminal such as a smartphone.

In addition, the web page outputter 121 may display a current user's data transaction condition and a list of marketable data, and allow a state of the data owned by the user to be checked at a glance. In addition, the web page outputter 121 may include the request display 129, and may display purchase requests generated by at least one purchaser.

Referring to FIG. 7 together, a data transaction page may be displayed on the display 120 via the web page outputter 121. The button display 123 may be included such that the user is able to approve the sale of the specific data, and the transaction may proceed when the user selects the sale of the data.

In addition, the web page outputter 121 may include detailed information of the marketable data via a content display 125, and may allow the data purchase request generated by the purchaser to be checked via the request display 125. Accordingly, the user may check various options for trading the data thereof and determine whether to sell the data.

The content display 125 is an area that provides information such that the user may check the data to be traded and determine whether to trade the data. The data transaction device 1 of the present disclosure may display information related to the TV usage data of the user, and may include, for example, the data collection period, the type of data that may be provided, network information, a data provision target, and the like. In addition, compensation information on the data provided by the user may be displayed together, and it may be guided that the user is able to receive the compensation by providing the TV usage data for a certain period of time.

The display of the present disclosure may provide an intuitive interface for the user to trade the data, and may allow the data sales and the compensation provision to be smoothly performed via the linkage with the user’s digital wallet. In addition, a user's transaction experience may be improved by providing the purchase request and a data sales state in real time.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

What is claimed is:

1. A device for collecting usage data of each user and trading the usage data using a blockchain network, the device comprising:
a data manager configured to collect raw usage data of the device and select marketable data from the raw usage data;
a blockchain registrator configured to register the marketable data in the blockchain network; and
a server configured to provide a service for trading the usage data and a communicator configured to be in communication with the blockchain network.

2. The device of claim 1, wherein the data manager is configured to generate summary information regarding the raw usage data, and select the marketable data based on a purchase request for the summary information.

3. The device of claim 1, further comprising an embedded wallet with cryptocurrency,
wherein the blockchain registrator is configured to pay a first transaction cost incurred in the registration using a balance held by the embedded wallet.

4. The device of claim 3, wherein the embedded wallet is configured to receive the first transaction cost from a purchaser of the marketable data.

5. The device of claim 1, further comprising a token issuer configured to issue a token related to the registered marketable data,
wherein the token includes an access key for checking the registered marketable data.

6. The device of claim 5, wherein the token issuer is configured to pay a second transaction cost incurred in the process of issuing the token using a balance held by an embedded wallet.

7. The device of claim 1, further comprising a display configured to display a screen thereon,
wherein the display includes:
a web page outputter configured to output a web page for trading the usage data; and
a button display configured to display a button for selling the usage data on the web page when a sales agreement is input from each user.

8. The device of claim 7, wherein the display further includes a linkage display configured to display linkage information for linking a digital wallet of each user with the data manager on the web page.

9. The device of claim 7, wherein the display further includes a request display configured to display a purchase request generated by at least one seller on the web page.

10. The device of claim 1, further comprising a sensor configured to sense a number of users.

11. A method for transacting data, the method comprising:
collecting raw usage data of a device used by a user;
selecting marketable data from the raw usage data;
registering the marketable data in a blockchain network;
issuing a token related to the registered marketable data; and
trading the token.

12. The method of claim 11, wherein the selecting of the marketable data includes:
generating summary information regarding the raw usage data;
receiving a purchase request for the summary information; and
selecting the marketable data from the raw usage data based on the purchase request.

13. The method of claim 11, wherein a first transaction cost incurred in the registering of the marketable data in the blockchain network is paid using a balance held by an embedded wallet included in the device,
wherein a second transaction cost incurred in the issuing of the token is paid using a balance held by the embedded wallet included in the device.

14. The method of claim 13, wherein the embedded wallet is configured to receive the first transaction cost or the second transaction cost from a purchaser of the marketable data.

15. The method of claim 11, wherein the token includes an access key for checking the registered marketable data.

16. A data transaction system comprising:
a device configured to generate summary information of usage data of a user, select marketable data required by a purchaser from the usage data, register the marketable data in a blockchain network, and issue a token regarding the registered marketable data;
a terminal of the user configured to execute a digital wallet linked with the device; and
a server configured to receive the summary information of the usage data from the device, provide the received summary information to a purchaser terminal, and receive a request for provision of the marketable data based on the summary information from the purchaser terminal,
wherein the server is configured to provide a reward for the token to the digital wallet of the user when the token is sold.
